(19) United States
(12) Patent Application Publication
(10) Pub. No.: US 2018/0358761 A1
(43) Pub. Date: Dec. 13, 2018

(54) FURNACE POWER HUB

(71) Applicant: Cecil R. White, Westland, MI (US)

(72) Inventor: Cecil R. White, Westland, MI (US)

(21) Appl. No.: 15/948,948

(22) Filed: Apr. 9, 2018

Related U.S. Application Data
(60) Provisional application No. 62/483,051, filed on Apr. 7, 2017.

(51) Int. Cl. H01R 13/70; H02J 3/38

(52) U.S. Cl. CPC H01R 13/70; H02J 3/381

(57) ABSTRACT

An apparatus for selectively receiving power from a remote power generator and from an electrical company power supply line includes an alternating current electrical connector configured to receive power from a remote power generator through a power cord. The apparatus further includes a power relay switch configured to provide power to a connected furnace device from a preselected preferred power supply source selected from the remote power generator and the electrical company power supply line.

### CROSS-REFERENCE TO RELATED APPLICATIONS

This disclosure claims priority to U.S. Provisional Patent Application 62/483,051 filed on Apr. 7, 2017, which is hereby incorporated by reference.

### TECHNICAL FIELD

This disclosure is related to an electrical circuit that can be provided or retrofitted upon a residential or commercial furnace, and, in particular, to a device useful to automatically switch a power source to the furnace to or from a power company electric line and a power generator.

### BACKGROUND

The statements in this section merely provide background information related to the present disclosure. Accordingly, such statements are not intended to constitute an admission of prior art.

Homes and businesses rely upon electrical power supplied by a power company. Under normal operation, power lines supply electrical power through an electrical box to systems and appliances within a home, for example, supplying 120 VAC in the United States.

Power from the power company can be interrupted. Storms, disasters, and other interruptions of service occur, and residents of a home can be adversely affected by such an interruption. Loss of some functionality can be tolerated. Ice can be purchased to keep food in a refrigerator from spoiling. Windows can be opened to cool a house and make up for loss of air conditioning. However, loss of use of a furnace in cold weather can be debilitating and difficult to compensate for. Harsh cold weather can make a home inhabitable, and significant damage can occur from pipes freezing.

Known power generators can make up for power loss. However, such systems can be difficult or expensive to connect to a home's electrical system. Expensive generators costing ten thousand dollars or more can be attached to a home's natural gas lines. Such systems have customized circuit boards or computerized systems that monitor operation of the power company circuits and automatically turn on and supply power to the home when power is lost. However, such systems are expensive, are located on an exterior of a home and are subject to theft, and are configured to power the home in an all or nothing configuration. Such systems work well for families with means to pay for such a dedicated system.

Smaller power generators are known. Gasoline or propane tank powered systems are known that can be wheeled around or carried around, for example, as can be useful to power devices for a recreational vehicle or other temporary needs. Such systems can be tied into an entire home, with expensive high voltage connections tied into a switch attached to the home's electrical box. Such systems are known to include a mechanical breaker switch that alternatively allows a person to select power from the power company or from the power generator tied into the electrical box containing all of the fuses for the home. Such systems are disadvantageous for a few reasons. One, the home owner must arrange to have the switch hardwired into electrical box by a certified electrician. This is again fine for a family with means, but not all families have disposable income to have such an auxiliary power hookup installed to the home. In a time of wide-spread power outages, electricians can be hard to come by. Further, such systems are tied into the power system for the entire house, meaning that the power draw for the entire home can easily exceed the allowable amount for a generator. Such a homeowner must be comfortable enough with the mechanical breaker switch to switch the power, and the homeowner must also be savvy enough to know how many watts the power generator can produce and how much power each of the systems and appliances in the house draw when activated. Such technical knowledge and comfort with manipulation of electrical systems can be a barrier for some users.

### SUMMARY

An apparatus for selectively receiving power from a remote power generator and from an electrical company power supply line includes an alternating current electrical connector configured to receive power from a remote power generator through a power cord. The apparatus further includes a power relay switch configured to provide power to a connected furnace device from a preselected preferred power supply source selected from the remote power generator and the electrical company power supply line.

### BRIEF DESCRIPTION OF THE DRAWINGS

One or more embodiments will now be described, by way of example, with reference to the accompanying drawings, in which:

FIG. 1 illustrates an exemplary furnace power relay switch, in accordance with the present disclosure;

FIG. 2 illustrates the furnace power relay switch of FIG. 1 installed to a furnace, in accordance with the present disclosure;

FIG. 3 schematically illustrates how the furnace power relay switch of FIG. 1 works, in accordance with the present disclosure;

FIG. 4 illustrates through a photograph an exemplary embodiment of the furnace power relay switch of FIG. 1, a portion of the outer surfaces painted red to aid in finding the switch during a power outage emergency, in accordance with the present disclosure; and

FIG. 5 illustrates through a photograph an alternative exemplary embodiment of the furnace power relay switch of FIG. 1, a portion of the outer surfaces painted red to aid in finding the switch during a power outage emergency and with two additional power outlets being present and powered from the same source as the attached furnace, in accordance with the present disclosure.

### DETAILED DESCRIPTION

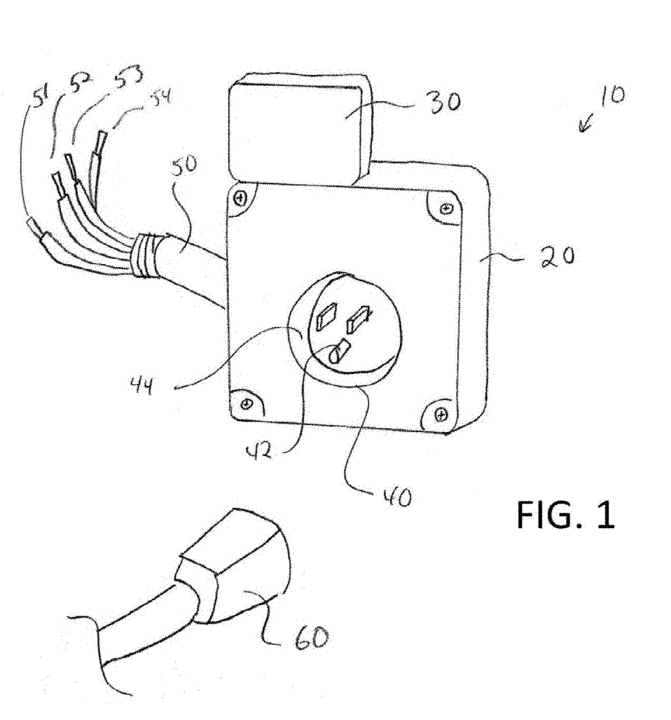

Referring now to the drawings, wherein the showings are for the purpose of illustrating certain exemplary embodiments only and not for the purpose of limiting the same, FIG. 1 illustrates an exemplary furnace power relay switch. Furnace power relay switch 10 is illustrated including junction and aux power input box 20, relay box 30, and wire tube 50. Relay box 30 includes a relay circuit capable of switching power between two circuits based upon the presence or absence of AC power being applied to a wire that is an input to the relay circuit. A non-limiting example of a relay that might be used within relay box 30 includes an enclosed pre-wired relay, 10 to 30 VAC/DC, 120 VAC, with a contact amp rating of 10A@277 VAC, 10A@28 VDC. An exemplary relay that works with the disclosed configuration is manufactured by the Functional Devices, Inc. company under the model number RIBU1C. This particular model is exemplary of relay circuits that can be used, although any functionally equivalent relay circuit can be utilized.

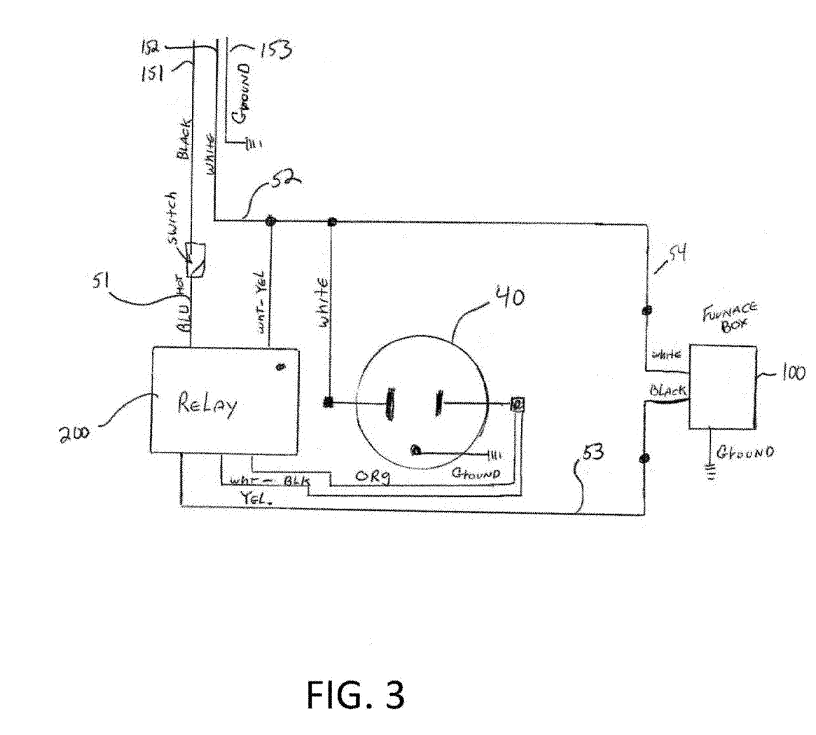

Junction and aux power input box 20 includes 120 VAC male connector 40 configured to accept a female end 60 of a typical extension cord. While any number of extension cords can be used, it will be appreciated that even small power generators as can be used to power a furnace with the disclosed furnace power relay switch must still be used outside in open areas. An extension cord configured to transmit power from the generator to the furnace over the required distance from the generator to the furnace power relay switch should be used. Junction and aux power input box 20 includes 120 VAC male connector 40 and internal wiring connected thereto. Junction and aux power input box 20 further includes a connection to wire tube 50 from which four wires, wires 51, 52, 53, and 54, extend. Junction and aux power input box 20 includes wire nuts connecting wires 51, 52, 53, and 54 with other wires and the relay circuit in accordance with the schematic of FIG. 3.

120 VAC male connector 40 includes a three prong connector for use in the United States. One will appreciate that the connector and accompanying circuitry could easy by additionally or alternatively provided in box 20 for other voltage connectors or connectors used in other countries. Connector 40 further includes an exemplary nylon lead in 42.

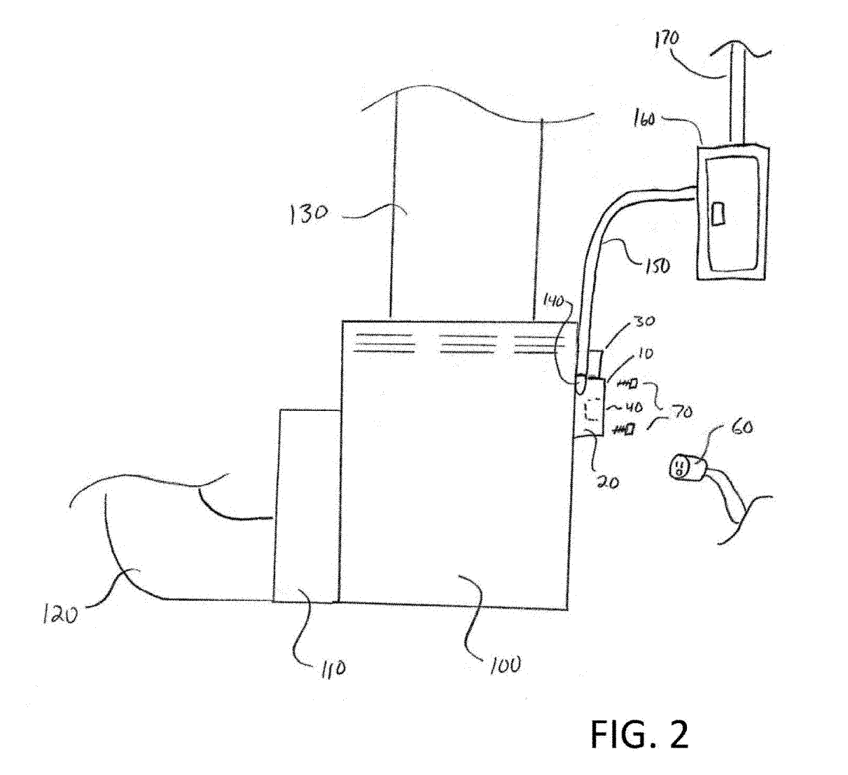

FIG. 2 illustrates the furnace power relay switch of FIG. 1 installed to a furnace. Furnace 100 is illustrated including air input duct 120, exemplary air filter box 110, and air outlet duct 130. Furnace 100 includes heating and blower devices known in the art. Furnace 100 can include mechanisms known in the art for generating heat from natural gas, heating oil, or other similar energy sources. Furnace 100 includes an electrically powered blower unit, which translates mechanical power from a spinning motor into moving air, which is moved through the heating device and then into air outlet duct 130. Both the blower unit and control and sensing circuitry within furnace 100 require electrical power to operate. Such power is usually provided from electrical company power supply line 150, which is routed to furnace 100 through electrical box 160 from infrastructure power supply 170.

Furnace power relay switch 10 is illustrated including junction and aux power input box 20 and relay box 30. Relay switch 10 can be installed by the factory upon or equivalently within furnace 100. In another embodiment, once can easily retrofit an existing furnace 100 by splicing into power supply line 150. Wires 51, 52, 53, and 54 of FIG. 1 are connected to either wires of power supply line 150 or wire bundle 140 entering furnace 100. Exemplary fasteners 70 are illustrated that can attach relay switch 10 to an external surface of furnace 100. Once installed, once power is interrupted from power supply line 150 by an exemplary storm, a user can press female end 60 of the extension cord into 120 VAC connector 40 of power relay 10, plug the other end of the extension cord into a remote generator unit, and power up the generator. The furnace will then function.

Exemplary furnaces require approximately 1200 Watts to operate. Small hand held power generators can provide such power. Other units that plug into home power systems typically require some minimum amount of power or require 240 Volt outputs, not present upon typical 1200 Watt generators, to operate. The disclosed relay switch enables use of small power generators or power generators with only 120 Volt outputs to be used to power the furnace where other power systems would not.

FIG. 3 schematically illustrates how the exemplary furnace power relay switch of FIG. 1 works. Relay circuit 200 is illustrated. Wires 151, 152, and 153 of a typical electrical company power supply line are illustrated. When power is present in wires 151 and 152, lines 51 and 52 are energized. Relay 200 is configured to provide power from lines 51 and 52 when such power is present. When such power is not present, relay 200 is configured to instead transmit power from 120 VAC connector 40. Power from relay 200 is provided to furnace 100 through wires 53 and 54. The circuit diagram of FIG. 3 illustrates one way that the desired functionality can be achieved. It will be appreciated that other similar or equivalent configurations can be utilized to the same effect, and the disclosure is not intended to be limited to the particular examples provided herein.

According to one embodiment, the power relay switch is configured to interrupt all power flow to and from the electrical connector and the associated remote generator device when electrical company power supply line is providing normal power. The power relay switch in this example only connects the circuitry to the electrical connector when the normal power supply from the electrical company power supply fails. The power relay switch can be configured to interrupt all power flow to and from the electrical connector when the extension cord is not attached to the electrical connector. This prevents anyone nearby the connector from being shocked by accidentally touching the prongs of the connector when power from the electrical company is powering the furnace.

According to another embodiment, the power relay switch is configured to interrupt all power flow to and from the electrical company power supply line when the extension cord is attached to the connector. In this example, the power relay switch favors power from the generator and does not accept power from the electrical company power supply until the generator cord is unplugged. Similarly, the power relay switch can be configured to interrupt all power flow to and from the electrical connector when the extension cord is not attached to the electrical connector. This prevents anyone nearby the connector from being shocked by accidentally touching the prongs of the connector when power from the electrical company is powering the furnace.

According to another example, the disclosed devices can provide power to a connected furnace device from a preselected preferred one of a remote power generator and an electrical company power supply line. Such a preference can be hard wired into the device, with the installed power relay automatically selecting the preferred power supply. In another embodiment, two power relays or a modifiable power relay can be utilized with a switch or selector control being provided to the user to determine which power supply is the preferred power supply.

According to one embodiment, the power relay switch is configured to only receive power from the generator connected to the electrical connector when the generator is attached to the electrical connector, for example, with an extension cord. Once the extension cord is removed from the electrical connector, then the power supply path from the electrical company is restored. Electrical power from the power supply company can be described as power company power. Electrical power from a remote power generator can be described as generator power.

Remote power generators can take many forms. Typical generators include 2 or 4 stroke gasoline engines connected to an electrical machine motor configured to generate electrical power based upon converting torque from the engine into current. In another example, propane fuel or natural gas fuel can be used to provide power to the generator engine. In another example, wind or solar energy can be used to provide the generator power. Any number of alternative remote power generator devices are envisioned, and the disclosure not intended to be limited to the particular examples provided herein.

An extension cord is typically used to connect a small electrical generator to the electrical connector of the disclosed devices. Any description of an extension cord or power cord within the disclosure is intended to include all electrical connection methods known in the art.

One having ordinary skill in the art will appreciate that embodiments of the power relay switch disclosed herein will include a ground fault diode which enables automated power switching depending upon conditions of inputs.

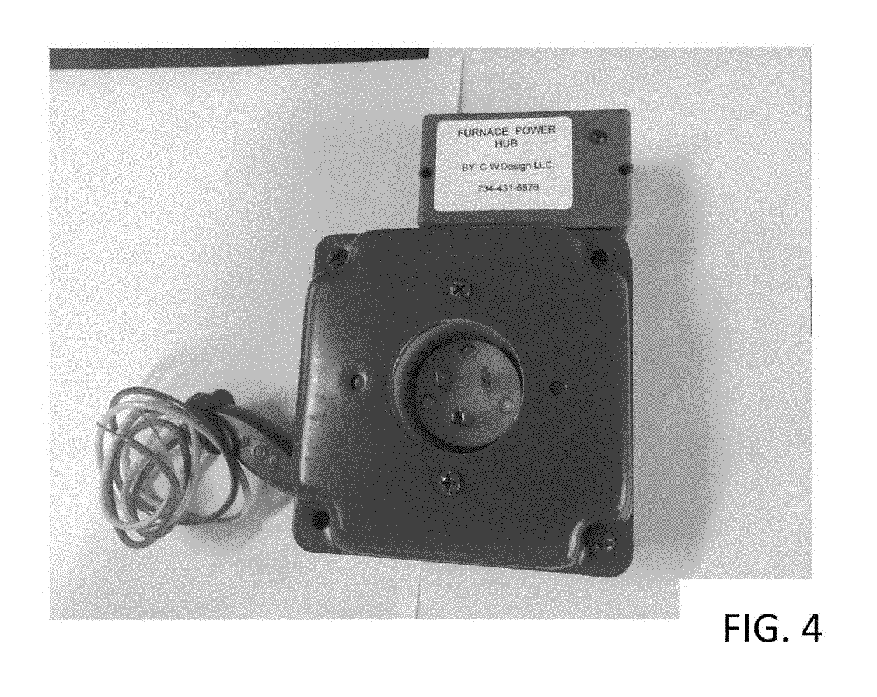

FIG. 4 illustrates through a photograph an exemplary embodiment of the furnace power relay switch of FIG. 1, a portion of the outer surfaces painted red to aid in finding the switch during a power outage emergency.

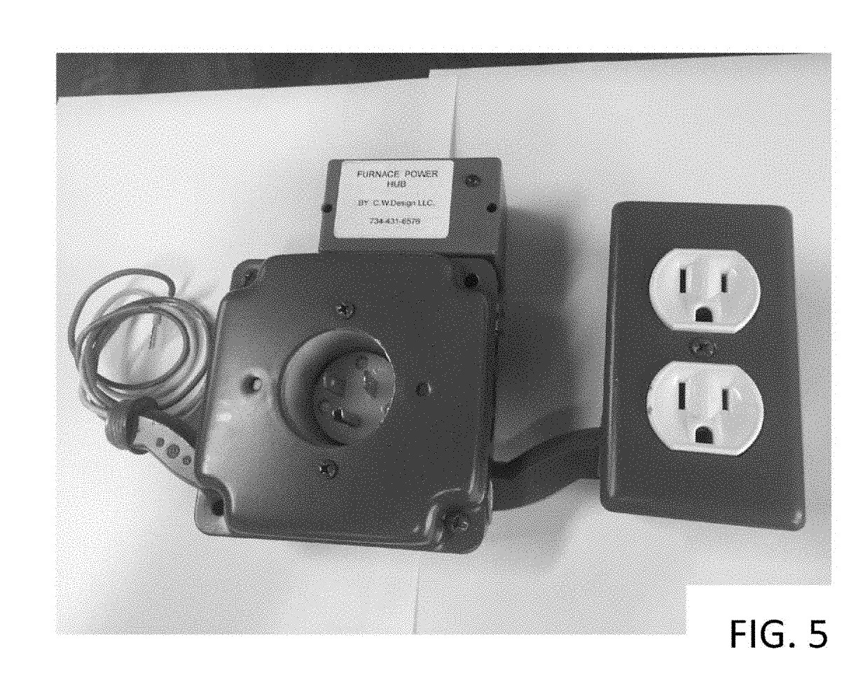

FIG. 5 illustrates through a photograph an alternative exemplary embodiment of the furnace power relay switch of FIG. 1, a portion of the outer surfaces painted red to aid in finding the switch during a power outage emergency and with two additional power outlets being present and powered from the same source as the attached furnace. In such an example, the two power outlets can be labeled for particular suggested uses, for example, powering a sump pump to keep water out of a basement and a hot water heater.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus for selectively receiving power from a remote power generator and from an electrical company power supply line, comprising:
an alternating current electrical connector configured to receive power from a remote power generator through a power cord; and
a power relay switch configured to provide power to a connected furnace device from a preselected preferred power supply source selected from the remote power generator and the electrical company power supply line.

2. The apparatus of claim 1, wherein the preselected preferred power supply source comprises the remote power generator; and
wherein the power relay switch is further configured to interrupt all power flow to and from the electrical company power supply line when the remote power generator is attached to the connector.

3. The apparatus of claim 1, wherein the preselected preferred power supply source comprises the electrical power company supply line; and
wherein the power relay switch is further configured to interrupt all power flow to and from the remote power generator when power is available from the electrical power company supply line.

4. The apparatus of claim 1, further comprising a selector switch enabling a user to select the preselected preferred power supply source.

5. An apparatus for selectively receiving power from a remote power generator and from an electrical company power supply line, comprising:
an alternating current electrical connector configured to receive power from a remote power generator through a power cord; and
a power relay switch configured to:
provide power to a residential furnace from the power cord when the power cord is attached to the electrical connector; and
provide power to the residential furnace from the electrical company power supply line when the power cord is not attached to the electrical connector.

6. The apparatus of claim 5, wherein the power relay switch is configured to interrupt all power flow to and from the electrical company power supply line when the power cord is attached to the connector.

7. The apparatus of claim 5, wherein the power relay switch is configured to interrupt all power flow to and from the electrical connector when the power cord is not attached to the electrical connector.

8. An apparatus for selectively receiving power from a remote power generator and from an electrical company power supply line, comprising:
an alternating current electrical connector configured to receive power from a remote power generator through a power cord; and
a power relay switch configured to:
provide power to a residential furnace from the electrical company power supply line when power from the electrical company power supply line is available; and
provide power to the residential furnace from the remote power generator when the power from the electrical company power supply line is not available.

9. The apparatus of claim 8, wherein the power relay switch is configured to interrupt all power flow to and from the electrical company power supply line when the power cord is attached to the connector.

10. The apparatus of claim 8, wherein the power relay switch is configured to interrupt all power flow to and from the electrical connector when the power cord is not attached to the electrical connector.
